(19) United States
(12) Patent Application Publication
(10) Pub. No.: US 2020/0192205 A1
(43) Pub. Date: Jun. 18, 2020

(54) ILLUMINATION UNIT AND DISPLAY APPARATUS

(71) Applicant: SONY CORPORATION, TOKYO (JP)

(72) Inventors: TOSHIFUMI YASUI, KANAGAWA (JP); YOSHIYUKI TERAOKA, KANAGAWA (JP); MASAHIRO ANDO, KANAGAWA (JP)

(21) Appl. No.: 16/323,278

(22) PCT Filed: Jun. 28, 2017
(86) PCT No.: PCT/JP2017/023687

§ 371 Date: Feb. 5, 2019

(30) Foreign Application Priority Data
Aug. 23, 2016 (JP) 2016-162770

(51) Int. Cl. G03B 21/20; G02B 27/48

(52) U.S. Cl. CPC G03B 21/208; G02B 27/48; G03B 21/2033

(57) ABSTRACT

An illumination unit includes a laser light source that intermittently emits laser light as a source of illumination light at a predetermined light emission frequency, a vibration device disposed in an optical path of the laser light, and a driver that vibrates the vibration device at a predetermined vibration frequency to change coherence of the laser light, in which, with respect to a design frequency f_{A} that satisfies

f_{A}−0.5≤f′_{A}≤f_{A}+0.5,

when a minimum value m (other than 0) that satisfies

m(f_{A}/f_{LD})−Round[m(f_{A}/f_{LD})]=0

is determined,

3≤m≤6

is satisfied, where f_{LD} is the light emission frequency and f′_{A} is the vibration frequency.

### TECHNICAL FIELD

The present disclosure relates to an illumination unit including a laser light source, and to a display apparatus that performs image display with use of such an illumination unit.

### BACKGROUND ART

In recent years, a projector that projects an image on a screen has been widely used not only at an office but also at home. The projector modulates light from a light source by a light valve (light modulation device) to generate image light, and projects the image light on the screen to perform display. In recent years, a palm-sized small projector using a solid-state light emitting device such as an LED (Light Emitting Diode) or an LD (Laser Diode) as a light source, a mobile telephone including the small projector, and the like have started to be widely used.

### CITATION LIST

### Patent Literature

### PTL 1: Japanese Unexamined Patent Application Publication No. 2013-231940

### PTL 2: Japanese Unexamined Patent Application Publication No. 2013-37335

### PTL 3: Japanese Unexamined Patent Application Publication No. 2008-203699

### SUMMARY OF INVENTION

A projector is commonly requested to reduce luminance unevenness (illuminance unevenness) in illumination light emitted from the illumination unit, to improve display quality.

It is desirable to provide an illumination unit and a display apparatus that make it possible to reduce luminance unevenness in illumination light.

An illumination unit according to an embodiment of the disclosure includes a laser light source that intermittently emits laser light as a source of illumination light at a predetermined light emission frequency, a vibration device disposed in an optical path of the laser light, and a driver that vibrates the vibration device at a predetermined vibration frequency to change coherence of the laser light. With respect to a design frequency f_{A} that satisfies

f_{A}−0.5≤f′_{A}≤f_{A}+0.5,

when the minimum value m (other than 0) that satisfies

m(f_{A}/f_{LD})−Round[m(f_{A}/f_{LD})]=0

is determined,

3≤m≤6

is satisfied, where f_{LD} is the light emission frequency and f′_{A} is the vibration frequency.

A display apparatus according to an embodiment of the disclosure includes an illumination unit, and a light modulation device that modulates illumination light from the illumination unit on the basis of an image signal. The illumination unit includes a laser light source that intermittently emits laser light as a source of the illumination light at predetermined light emission frequency, a vibration device disposed in an optical path of the laser light, and a driver that vibrates the vibration device at a predetermined vibration frequency to change coherence of the laser light. With respect to a design frequency f_{A} that satisfies

f_{A}−0.5≤f′_{A}≤f_{A}+0.5,

when the minimum value m (other than 0) that satisfies

m(f_{A}/f_{LD})−Round[m(f_{A}/f_{LD})]=0

is determined,

3≤m≤6

is satisfied, where f_{LD} is the light emission frequency and f′_{A} is the vibration frequency.

In the illumination unit or the display apparatus according to the embodiment of the disclosure, a relationship between the light emission frequency of the laser light source and the vibration frequency of the vibration device may be optimized to a predetermined condition where luminance unevenness is less likely to be perceived.

According to the illumination unit or the display apparatus of the embodiment of the disclosure, the relationship between the light emission frequency of the laser light source and the vibration frequency of the vibration device is optimized to the predetermined condition where the luminance unevenness is less likely to be perceived. This makes it possible to reduce luminance unevenness in the illumination light.

Note that the effects described here are not necessarily limited, and any of effects described in the disclosure may be achieved.

### BRIEF DESCRIPTION OF DRAWINGS

FIG. 1 is a configuration diagram illustrating an example of a display apparatus according to an embodiment of the disclosure.

FIG. 2 is an explanatory diagram illustrating an example of a light emission frequency of a laser light source.

FIG. 3 is a configuration diagram schematically illustrating a configuration example of a vibration device.

FIG. 4 is a partial enlarged view illustrating an example of a surface shape of the vibration device.

FIG. 5 is an explanatory diagram illustrating an example of luminance unevenness during vibration being stopped that is occurred in a case where vibration of the vibration device is stopped.

FIG. 6 is an explanatory diagram illustrating the luminance unevenness during vibration being stopped in a simplified manner.

FIG. 7 is an explanatory diagram illustrating an example of luminance unevenness occurred in a case where a vibration frequency and the light emission frequency is equal to each other.

FIG. 8 is an explanatory diagram illustrating an example of luminance unevenness occurred in a case where the vibration frequency is 1.5 times the light emission frequency.

FIG. 9 is an explanatory diagram illustrating an example of a relationship between the vibration frequency and the number of fringes observed as the luminance unevenness.

FIG. 10 is an explanatory diagram illustrating an example of luminance unevenness occurred in a case where the vibration frequency is 50 Hz and the light emission frequency is 60 Hz.

FIG. 11 is an explanatory diagram illustrating an example of a relationship between a vibration temporal frequency and sensitivity.

FIG. 12 is an explanatory diagram illustrating an example of color difference according to in-plane luminance unevenness.

### MODES FOR CARRYING OUT THE INVENTION

Some embodiments of the disclosure are described in detail below with reference to drawings. Note that description is given in the following order.

0. Comparative example

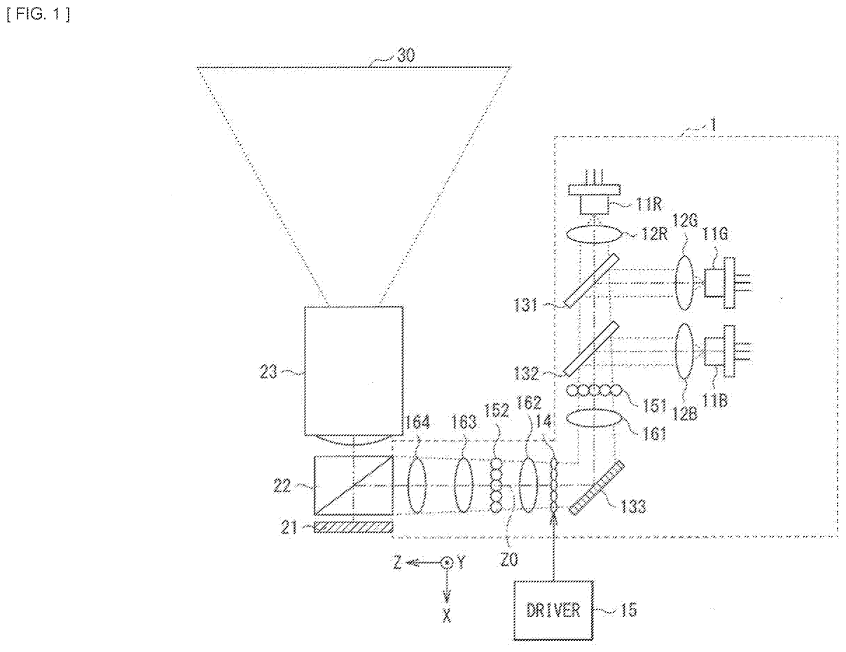

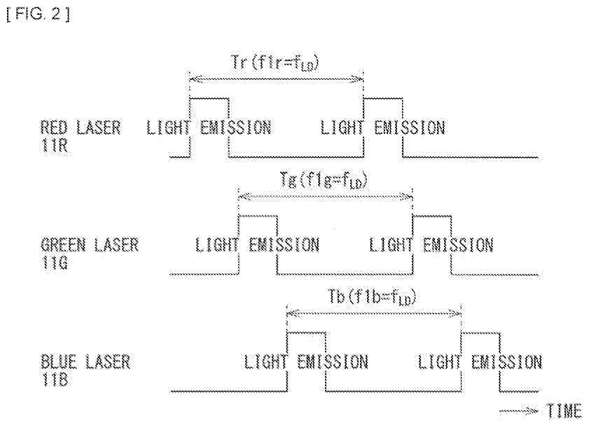

1. Overall description of display apparatus (FIG. 1 and FIG. 2)

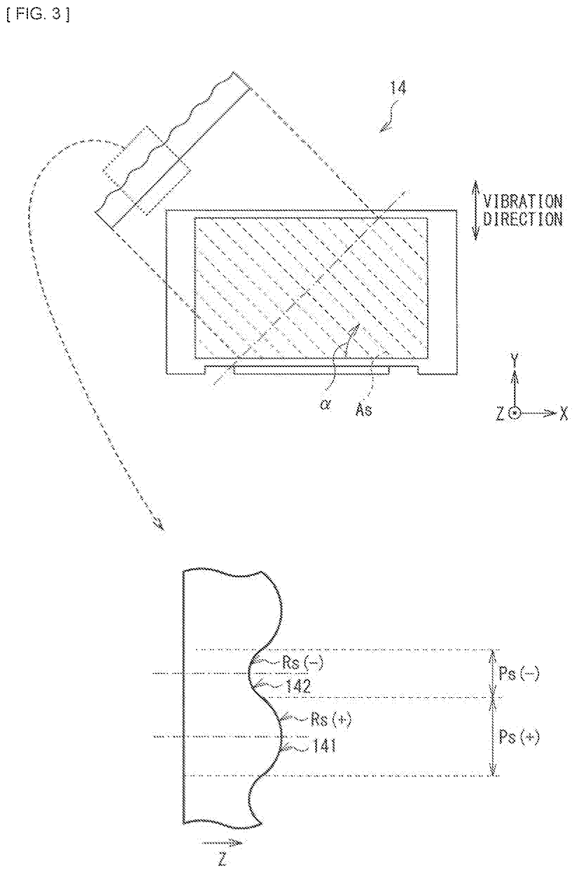

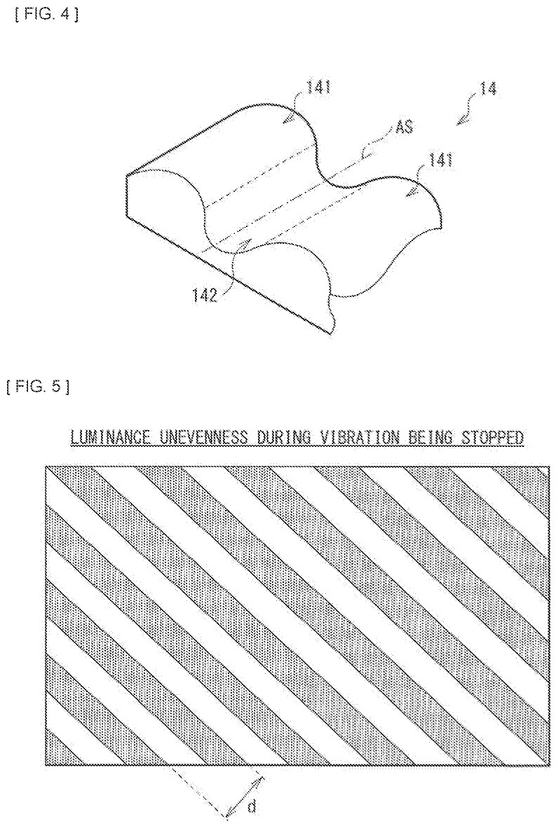

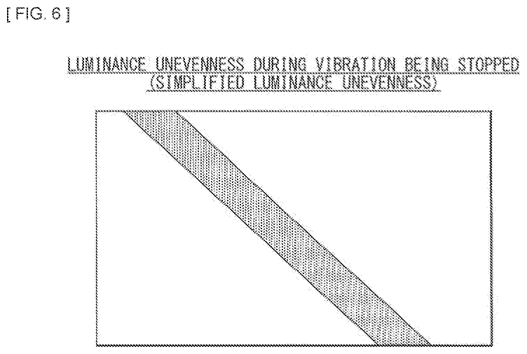

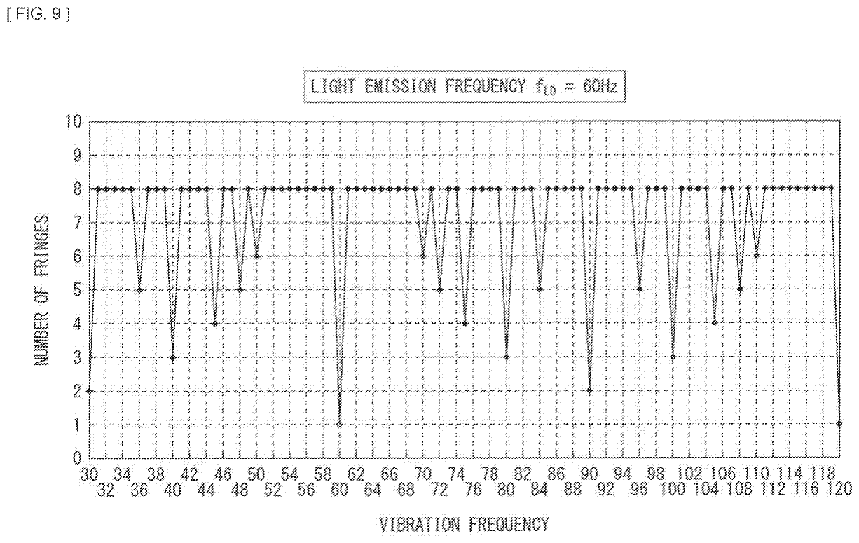

2. Description of technique of reducing luminance unevenness by vibration device
2.1 Configuration example of vibration device (FIG. 3 and FIG. 4)
2.2 Issues (FIG. 5 to FIG. 8)
2.3 Method of optimizing condition reducing luminance unevenness (FIG. 9 to FIG. 12)

3. Effects

4. Other embodiments

### 0. Comparative Example

As one of factors to determine image quality of a projector, there is uniformity of illuminance such as brightness and color in a screen. The projector commonly uses an integrator including a fly-eye lens, etc. to reduce luminance unevenness of illumination light (to uniformize luminance of illumination light). Even when the integrator is used, however, the luminance unevenness of the illumination light may not be sufficiently reduced (luminance distribution may not become uniform) due to speckle noise, interference fringes that are caused by a periodic structure of a fly-eye lens, etc., in particular, in a case where a laser is used as the light source. Accordingly, further improvement is demanded.

PTL 1 (Japanese Unexamined Patent Application Publication No. 2013-231940), etc. proposes that an optical device including a periodic structure is inserted into an optical path of laser light, and the optical device is vibrated to reduce luminance unevenness such as speckle. The effect of reducing the luminance unevenness may not be sufficiently obtained depending on a relationship between a light emission frequency of a laser light source and a vibration frequency of the optical device.

### 1. Overall Description of Display Apparatus

### [Overall Configuration of Display Apparatus]

FIG. 1 illustrates a configuration example of a display apparatus according to an embodiment of the disclosure.

The display apparatus according to the present embodiment is a projector that projects an image (image light) on a screen 30 (projection surface), and includes an illumination unit 1 and an optical system (display optical system) that performs image display with use of illumination light from the illumination unit 1.

Note that, in FIG. 1, an axis parallel to an optical axis Z0 is defined as a Z axis. Further, an axis parallel to a horizontal axis (lateral axis) in a cross-section orthogonal to the Z axis is defined as an X axis, and an axis parallel to a perpendicular axis (vertical axis) in the cross-section orthogonal to the Z axis is defined as a Y axis. Similar definition may be applied to the following other drawings.

### (Illumination Unit 1)

The illumination unit 1 includes a red laser 11R, a green laser 11G, a blue laser 11B, coupling lenses 12R, 12G, and 12B, dichroic mirrors 131 and 132, a reflection mirror 133, first and second lens arrays 151 and 152, and relay lenses 161, 162, 163, and 164. The illumination unit 1 further includes a vibration device 14 and a driver 15.

The red laser 11R, the green laser 11G, and the blue laser 11B are three kinds of laser light sources respectively emitting red laser light, green laser light, and blue laser light. A light source section includes these laser light sources. Each of the red laser 11R, the green laser 11G, and the blue laser 11B includes, for example, a semiconductor laser or a solid-state laser. A wavelength λr of the red laser light by the red laser 11R is within a range of about 600 nm to about 700 nm, more specifically, may be about 640 nm. A wavelength λg of the green laser light is within a range of, for example, about 500 nm to about 600 nm, more specifically, may be about 520 nm. A wavelength λb of the blue laser light is within a range of, for example, about 400 nm to about 500 nm, more specifically, may be about 445 nm.

FIG. 2 illustrates an example of a light emission frequency of each of the laser light sources. Each of the laser light sources intermittently emits laser light as a source of illumination light at a predetermined light emission frequency f_{LD}. The red laser 11R, the green laser 11G, and the blue laser 11B as the laser light sources each perform pulse light emission, for example, in a manner illustrated in FIG. 2. In other words, the red laser 11R intermittently (discontinuously) emits red laser light at a predetermined light emission frequency f1r [Hz] (light emission period Tr=1/f1r). The green laser 11G intermittently emits green laser light at a predetermined light emission frequency f1g [Hz] (light emission period Tg=1/f1g). The blue laser 11B intermittently emits blue laser light at a predetermined light emission frequency f1b [Hz] (light emission period Tb=1/f1b). Further, in this example, as illustrated in FIG. 2, the red laser light, the green laser light, and the blue laser light are sequentially emitted in this order in a time-divisional manner. Here, the light emission frequencies f1r, f1g, and f1b each indicate a corresponding basic frequency. Note that, in this case, as an example, it is assumed that the light emission frequencies f1r, f1g, and f1b are equivalent to one another and are set to f_{LD} (in the following, appropriately described as f1r=f1g=f1b=f_{LD}).

Note that the light emission frequency f_{LD} is desirably optimized so as to satisfy a condition reducing luminance unevenness described later.

The coupling lenses 12R and 12G are lenses to respectively collimate the red laser light emitted from the red laser 11R and the green laser light emitted from the green laser 11G (into parallel light), to couple the collimated light to the dichroic mirror 131. Likewise, the coupling lens 12B is a lens to collimate the laser light emitted from the blue laser 11B (into parallel light), to couple the collimated light to the dichroic mirror 132. Note that, in this example, the entered laser light is collimated (into parallel light) by the coupling lenses 12R, 12G, and 12B; however, the configuration is not limited to the case. The laser light may not be collimated by the coupling lenses 12R, 12G, and 12B (into parallel light). Collimating, however, is desirably performed as described above because it is possible to downsize the apparatus configuration.

The dichroic mirror 131 selectively allows the red laser light entered through the coupling lens 12R to pass therethrough, whereas selectively reflects the green laser light entered through the coupling lens 12G. The dichroic mirror 132 selectively allows the red laser light and the green laser light outputted from the dichroic mirror 131 to pass therethrough, whereas selectively reflects the blue laser light entered through the coupling lens 12B. As a result, color synthesis (optical path synthesis) of the red laser light, the green laser light, and the blue laser light is performed.

Note that a dichroic prism may be used in place of each of the dichroic mirrors 131 and 132.

The first lens array 151, the relay lens 161, the reflection mirror 133, the vibration device 14, the relay lens 162, the second lens array 152, the relay lens 163, and the relay lens 164 are disposed in this order in the optical path of the color-synthesized laser light.

Each of the first lens array 151 and the second lens array 152 may be a fly-eye lens in which a plurality of unit lenses are two-dimensionally arranged on a substrate. For example, the first lens array 151 and the relay lenses 161 and 162 have action of pupil uniformization. Further, for example, the second lens array 152 and the relay lenses 163 and 164 have action of illumination light uniformization.

The vibration device 14 is a device to reduce luminance unevenness caused by speckle noise (interference pattern), etc. The illumination unit 1 is configured such that the vibration device 14 is disposed in an optical path between the first lens array 151 and the second lens array 152, and is vibrated to achieve an effect to reduce the luminance unevenness.

The driver 15 vibrates (finely vibrates) the vibration device 14 at a predetermined vibration frequency to change coherence of the laser light. A vibration direction of the vibration device 14 by the driver 15 is, for example, the Y-axis direction. The driver 15 includes, for example, a coil and a permanent magnet (e.g., permanent magnet including material such as neodymium (Nd), iron (Fe), and boron (B)).

Note that the vibration frequency of the vibration device 14 is desirably optimized so as to satisfy the condition reducing the luminance unevenness described later.

### (Display Optical System)

The above-described display optical system includes a polarization beam splitter (PBS) 22, a reflective liquid crystal device 21, and a projection lens 23 (projection optical system).

The polarization beam splitter 22 is an optical member that selectively reflects specific polarized light (e.g., s-polarized light), and selectively allows the other polarized light (e.g., p-polarized light) to pass therethrough as well. As a result, the illumination light (e.g., s-polarized light) from the illumination unit 1 is selectively reflected by the polarization beam splitter 22 so as to enter the reflective liquid crystal device 21, and image light (e.g., p-polarized light) outputted from the reflective liquid crystal modulation device 21 selectively passes through the polarization beam splitter 22 so as to enter the projection lens 23.

For example, the polarization beam splitter 22 may include a configuration in which prisms coated with a multilayer film are bonded to each other. Further, the polarization beam splitter 22 may be a device including polarization characteristics (e.g., wire grid or polarization film), or a beam splitter similar to a prism sandwiching the device.

The reflective liquid crystal device 21 is a light modulation device that outputs the image light by reflecting the illumination light from the illumination unit 1 while modulating the illumination light on the basis of an image signal supplied from an unillustrated display controller. At this time, the reflective liquid crystal device 21 performs reflection such that polarized light in entering and polarized light in outputting (e.g., s-polarized light or p-polarized light) are different from each other. Such a reflective liquid crystal device 21 includes a liquid crystal device such as LCOS (Liquid Crystal On Silicon).

The projection lens 23 is a projection optical system that projects (enlarges and projects) the illumination light (image light) modulated by the reflective liquid crystal device 21, on the projection surface (screen 30).

### (Display Operation)

In the display apparatus, in the illumination unit 1, the light (laser light) emitted from the red laser 11R, the green laser 11G, and the blue laser 11B are first respectively collimated by the coupling lenses 12R, 12G, and 12B into parallel light. Next, the laser light (red laser light, green laser light, and blue laser light) thus collimated into the parallel light is subjected to color synthesis (optical path synthesis) by the dichroic mirrors 131 and 132. The laser light that has subjected to the optical path synthesis passes through the first lens array 151, the relay lens 161, the vibration device 14, the relay lens 162, the second lens array 152, and the relay lenses 163 and 164 in order. As a result, the laser light is uniformized in in-plane luminance, and the resultant light is emitted as illumination light from the illumination unit 1.

Next, the illumination light is selectively reflected by the polarization beam splitter 22, and the reflected illumination light enters the reflective liquid crystal device 21. In the reflective liquid crystal device 21, the entering light is reflected while being modulated on the basis of the image signal, and the resultant light is outputted as the image light. At this time, since the polarized light is different between in entering and in outputting in the reflective liquid crystal device 21, the image light outputted from the reflective liquid crystal device 21 is selectively transmitted through the polarization beam splitter 22 and enters the projection lens 23. Thereafter, the entering light (image light) is projected (enlarged and projected) on the screen 30 by the projection lens 23.

At this time, the red laser 11R, the green laser 11G, and the blue laser 11B sequentially generate light (perform pulse light emission) at the predetermined light emission frequency f_{LD} in a time-divisional manner, and emit laser light (red laser light, green laser light, and blue laser light). In addition, in the reflective liquid crystal device 21, the color laser light is sequentially modulated in a time-divisional manner on the basis of a corresponding image signal of each of the color components (red component, green component, and blue component). As a result, color image display based on the image signals is performed in the display apparatus.

### 2. Description of Technique of Reducing Luminance Unevenness by Vibration Device

### [2.1 Configuration Example of Vibration Device]

FIG. 3 schematically illustrates a configuration example of the vibration device 14. FIG. 4 illustrates an example of a surface shape of the vibration device 14.

The vibration device 14 includes a periodic structure, for example, a periodic concavo-convex surface on both of a light entering surface and a light outputting surface, or any one of the light entering surface and the light outputting surface. Note that the vibration device 14 may include the periodic structure in a first periodic direction and in a second periodic direction that are different from each other, on any one of the light entering surface and the light outputting surface. Further, the vibration device 14 may include the periodic structure in directions different from each other on both of the light entering surface and the light outputting surface.

FIG. 3 illustrates an example in which the vibration device 14 includes the periodic structure in an oblique direction on any one of the light entering surface and the light outputting surface.

The vibration device 14 includes a first optical surface 141 that outputs the entered laser light while converging the entered laser light, and a second optical surface 142 that outputs the entered laser light while diffusing the entered laser light, on at least one of the light entering surface and the light outputting surface.

In the vibration device 14, the first optical surface 141 and the second optical surface 142 are coupled to each other such that an optical path of the converged light outputted from the first optical surface 141 and an optical path of the diffused light outputted from the second optical surface 142 are continuously changed.

In the optical device 14, a pitch of the first optical surface 141 and a pitch of the second optical surface 142 may be different from each other.

Here, the structure of the vibration device 14 in a case where the vibration device 14 includes the surface shape in FIG. 4 is described as an example. In the case of the surface shape in FIG. 4, the vibration device 14 includes a structure in which the first optical surface 141 including a convex curved surface and the second optical surface 142 including a concave curved surface are alternately arranged (one-dimensionally arranged). Here, in FIG. 3, the pitch of the first optical surface 141 is denoted by Ps(+), a radius of curvature of the first optical surface 141 is denoted by Rs(+), the pitch of the second optical surface 142 is denoted by Ps(−), and a radius of curvature of the second optical surface 142 is denoted by Rs(−). In this example, the pitch Ps(+) of the first optical surface 141 and the pitch Ps(−) of the second optical surface 142 are different from each other (here, Ps(+)>Ps(−) is established).

In the case of the surface shape in FIG. 4, the vibration device 14 has a cylindrical lens array shape in which the first optical surface 141 and the second optical surface 142 extend along the same direction. In the example of FIG. 3, the vibration device 14 includes a structure in which an optical surface extending axis As has an inclination angle α to the X direction. As a result, the structure of the vibration device 14 is a structure in which the cylindrical lens array is disposed in the oblique direction.

Note that the structure is not limited to the example of FIG. 3, and a structure in which the optical surface extending axis As is made parallel to the X direction and the cylindrical lens array is horizontally disposed may be used.

### [2.2 Issues]

FIG. 5 illustrates an example of luminance unevenness during vibration being stopped that is occurred in a case where the vibration of the vibration device 14 is stopped. FIG. 5 illustrates the example of the luminance unevenness during vibration being stopped in a case where the vibration device 14 includes the structure as illustrated in FIG. 3 and FIG. 4 described above. Further, FIG. 5 illustrates an example of the luminance unevenness on the projection surface (screen 30).

In the case where the vibration device 14 includes the structure in which the cylindrical lens array is disposed in the oblique direction, oblique fringes including bright parts and dark parts may periodically appear as the luminance unevenness, as illustrated in FIG. 5. The driver 15 may vibrate the vibration device 14 to reduce the luminance unevenness occurred on the projection surface more than the luminance unevenness during vibration being stopped. In the case where the driver 15 vibrates the vibration device 14, the luminance unevenness as illustrated in FIG. 5 is vibrated, and as a result, the luminance unevenness becomes less likely to be perceived. Further, the speckle and the interference fringes may also be reduced by the vibration of the vibration device 14 according to the same principle.

Even when the vibration device 14 is vibrated, however, the luminance unevenness may actually partially remain and may be distinctly perceived depending on a relationship between timing of intermittent light emission of the laser light source (light emission frequency f_{LD}) and timing of vibration of the vibration device 14 (vibration frequency).

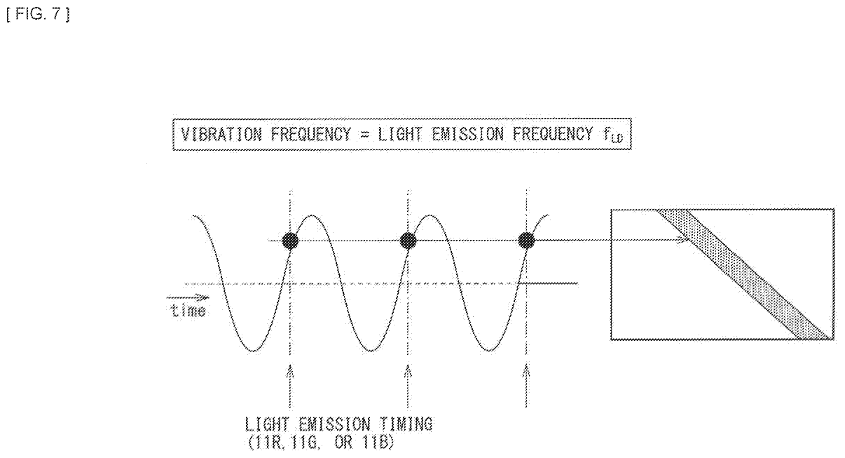

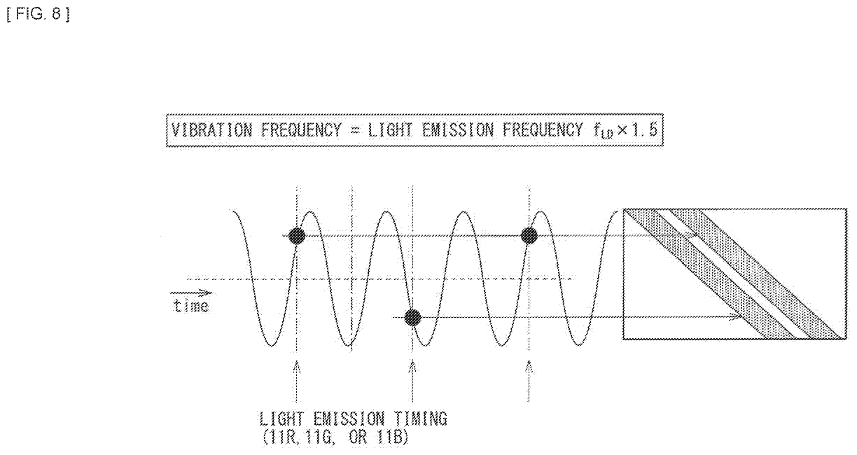

FIG. 6 illustrates the luminance unevenness during vibration being stopped in a simplified manner. FIG. 7 illustrates an example of luminance unevenness occurred in a case where the vibration frequency and the light emission frequency f_{LD} are equal to each other. FIG. 8 illustrates an example of luminance unevenness in a case where the vibration frequency is 1.5 times the light emission frequency f_{LD}.

To simplify the description, it is assumed that the luminance unevenness during vibration being stopped is one fringe as illustrated in FIG. 6. At this time, if the laser light source continuously emits light when the vibration device 14 is vibrated, a state where the luminance unevenness is vertically moved is observed in synchronization with the vibration frequency of the vibration device 14. However, the laser light source actually intermittently emits light, and different luminance unevenness is accordingly perceived. For example, in the case where the light emission frequency f_{LD} of the intermittent light emission of the laser light source and the vibration frequency of the vibration device 14 are equal to each other as illustrated in FIG. 7, light emission by the laser light source is certainly performed and perceived only when the vibration device 14 passes through a specific position. Accordingly, the luminance unevenness is observed as if the luminance unevenness stops at a fixed position. As a result, density of the luminance unevenness is enhanced, and the luminance unevenness is easily perceived by the user, and thus unsuitable.

On the other hand, for example, in the case where the vibration frequency of the vibration device 14 is 1.5 times the light emission frequency f_{LD} of the laser light source as illustrated in FIG. 8, the laser light source emits light when the vibration device 14 is located at specific two positions. Therefore, the luminance unevenness is observed at the two positions. As a result, the density of the luminance unevenness itself is reduced to half, and the luminance unevenness becomes less likely to be perceived.

As described above, perception of the luminance unevenness may be changed depending on the relationship between the light emission frequency f_{LD} and the vibration frequency. Therefore, the condition reducing the luminance unevenness is desirably determined on the basis of the light emission frequency f_{LD} and the vibration frequency. In the following, a method of optimizing the condition reducing the luminance unevenness is described.

### [2.3 Method of Optimizing Condition Reducing Luminance Unevenness]

### (Formulation)

The above-described relationship of the light emission frequency f_{LD}, the vibration frequency, and the fringe-like luminance unevenness is formulated. In this case, the vibration frequency of the vibration device 14 is denoted by f_{A}, and the light emission frequency of the laser light source is denoted by f_{LD}. Note that, as described later, eventually, a theoretical vibration frequency (design frequency) of the vibration device 14 is defined as f_{A}, and an actual vibration frequency of the vibration device 14 is defined as f′_{A}; however, the vibration frequency of the vibration device 14 is initially described as f_{A} for description.

A position y of the fringe on the projection surface is expressed by

y=A sin(2πf_{A}t).

The laser light source intermittently emits light. Therefore, when the value m is set to

m=0,1,2, . . . ,

timing of the fringe actually observed is expressed by

t=m(1/f_{LD}),

and as a result, the position y of the fringe on the projection surface is expressed by

y=A sin[2πm(f_{A}/f_{LD})].

At this time, the number of values y that may be obtained when the value m is set to m=0, 1, 2, . . . , ∞ corresponds to the number of fringes.

Namely, when the value m is increased like 0, 1, 2, . . . , ∞, the minimum value m where

m(f_{A}/f_{LD})

becomes an integer is the number of fringes.

In other words, the minimum value m (other than 0) that satisfies

m(f_{A}/f_{LD})−Round[m(f_{A}/f_{LD})]=0

is the number of fringes. Note that Round indicates rounding off of decimal places.

FIG. 9 illustrates an example of a relationship between the vibration frequency f_{A} and the number of fringes observed as luminance unevenness. In FIG. 9, the light emission frequency f_{LD} of the laser light source is set to 60 Hz, the vibration frequency f_{A} is plotted in a lateral axis, and the number of fringes is plotted in a vertical axis. It is found that the number of fringes m is varied depending on the vibration frequency f_{A}.

### (Optimum Value m)

The number of fringes m has an optimum value. As described above, the dense luminance unevenness is easily observed and is easily perceived by the user as the value m is smaller because the fringes are largely overlapped. In contrast, if the value m is excessively large, vibration of the fringe is easily perceived.

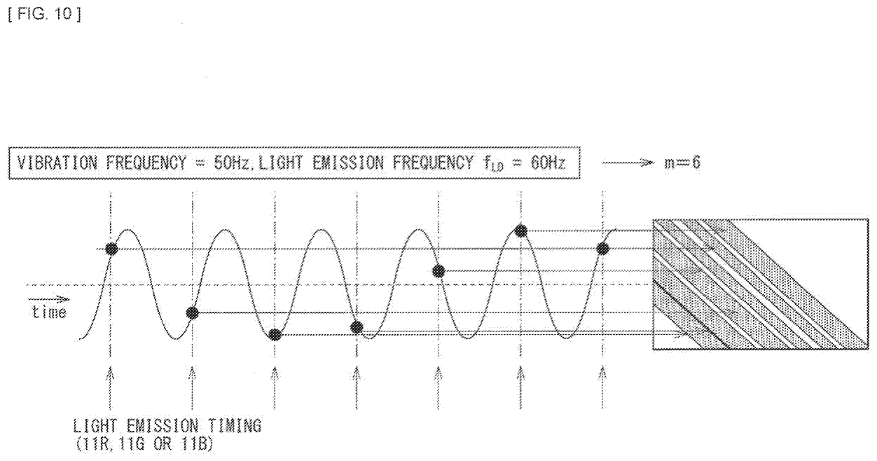

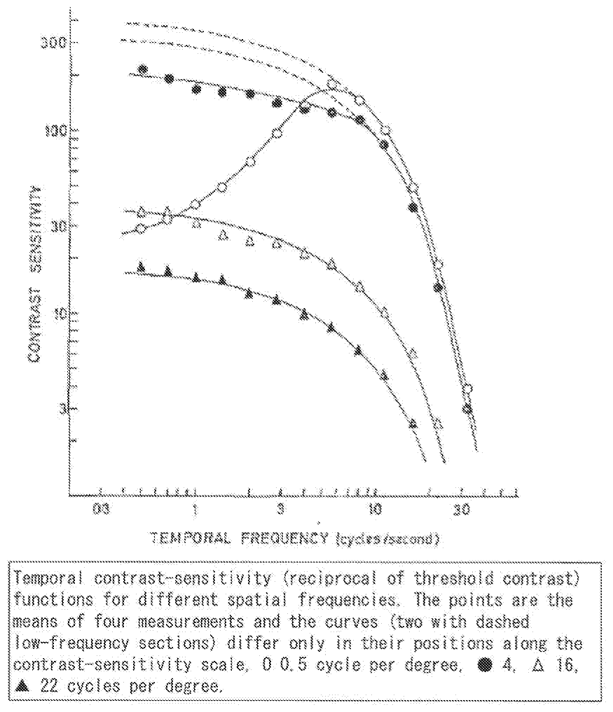

FIG. 10 illustrates an example of luminance unevenness occurred in a case where the vibration frequency f_{A} is 50 Hz, and the light emission frequency f_{LD} is 60 Hz, as an example of the case where the value m is large. When the number of fringes is denoted by m, a fluctuation frequency f_{Mura} of luminance unevenness follows

f_{Mura}=f_{LD}/m.

In other words, a vibration temporal frequency of the luminance unevenness is equivalent to 1/m of the light emission frequency f_{LD} of the laser light source, and vibration is easily perceived as the value m becomes large.

For example, more specifically, “Robson J G: “Spatial and temporal contrast-sensitivity functions of the visual system.” Journal of the Optical Society of America, 56:1141-1142, 1966.” describes a relationship between a vibration temporal frequency and a temporal frequency sensitivity for each spatial frequency as illustrated in FIG. 11. The sensitivity is sharply decreased at the vibration temporal frequency exceeding about 10 Hz with respect to any of spatial frequencies. In this respect, the fluctuation frequency f_{Mura} should be set to about 10 Hz or more. In a case where the light emission frequency f_{LD} of the laser light source is 60 Hz, the value m≤6 is desirable.

Further, the value m≥3 is desirable, for the following reasons. First, the luminance unevenness during the vibration device 14 being stopped is desirably suppressed to in-plane luminance unevenness of about Δ10%. This is because, when the luminance unevenness is excessively large, the reduction effect by driving of the vibration device 14 is limited, and it is necessary to suppress light quantity loss.

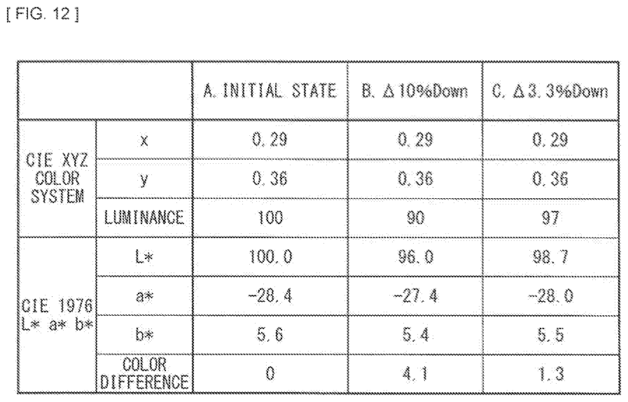

FIG. 12 illustrates an example of color difference according to the in-plane luminance unevenness. FIG. 12 illustrates color space parameters of the illumination light by XYZ color system and L*a*b* color system that are CIE (Commission Internationale de l'Eclairage) color systems. Here, it is assumed that the wavelengths of the red laser 11R, the green laser 11G, and the blue laser 11B as the laser light source are respectively 640 nm, 520 nm, and 445 nm. In this case, it is assumed that chromaticity as illustrated in an A column (initial state) of FIG. 12 is set on the premise that the light emission time and the power of the laser light source of each color are appropriately set, white balance is adjusted, and luminance of about 100 lm is obtained.

Chromaticity in a case where the luminance is decreased by Δ10% from the luminance in the A column (initial state) of FIG. 12 is illustrated in a B column of FIG. 12. At this time, the color difference is 4.1, and it is estimated that the reduction of the in-plane luminance unevenness is insufficient in a case of neighboring colors under vibration. This indicates that the value m=1 is insufficient.

In contrast, in a case of the value m=3, the level of the in-plane luminance unevenness is decreased to one-third. This corresponds to a case where the luminance is decreased by Δ3.3%. The chromaticity in the case where the luminance is decreased by Δ3.3% is illustrated in a C column of FIG. 12. The color difference in this case is about 1.3. It can be said that the in-plane luminance unevenness is substantially inconspicuous at the color difference of this level. Accordingly, the value m≤3 is desirable. Note that the conclusion is not changed as long as white is represented by mixing RGB colors even if the wavelengths of the laser light sources are varied, a target value of the white balance is varied, or the brightness is changed.

According to the results of the actual examination by the present disclosers, the appropriate range of the value m is 3≤m≤6, and it is confirmed that the luminance unevenness is easily perceived if the value m deviates from the range. The emission frequency f_{LD} of the laser light source is commonly often set to 50 Hz or higher so as to be less likely to be perceived by a person, and the above-described expression is substantially established in this range.

### (Vibration Frequency Range of Vibration Device 14)

Further, the actual vibration frequency f′_{A} of the vibration device 14 may be slightly shifted from the theoretical vibration frequency f_{A} determined above. Here, a case where the actual vibration frequency f′_{A} is shifted to 50.5 Hz on the basis of the light emission frequency f_{LD} of 60 Hz and the theoretical vibration frequency f_{A} of 50 Hz is assumed. When the theoretical vibration frequency f_{A} is 50 Hz, the value m is 6, and the vibration device 14 includes 5 cycles in 0.1 sec, as with the case illustrated in FIG. 10. When a framework of 0.1 sec is similarly considered because variation from 50 Hz to 50.5 Hz is very small, the vibration device 14 includes 5.05 cycles, and fluctuation cycle difference of at most 1% is experientially less likely to be perceived as difference by human eyes. Likewise, when the theoretical vibration frequency f_{A} is 80 Hz, the value m is 3, and the vibration device 14 includes 4 cycles in 0.05 sec. The variation of the theoretical vibration frequency f_{A} from 80 Hz to 80.5 Hz corresponds to 4.025 cycles from a similar calculation, and the fluctuation cycle difference of at most 0.625% is experientially less likely to be perceived as difference by human eyes. Accordingly, the actual vibration frequency f′_{A} of the vibration device 14 actually includes a margin of about 0.5 Hz with respect to the theoretical vibration frequency f_{A} used in the calculation expression.

In other words, it is sufficient to calculate the condition with use of f_{A}, a design frequency, that satisfies

f_{A}−0.5≤f′_{A}≤f_{A}+0.5.

More specifically, with respect to the design frequency f_{A} that satisfies

f_{A}−0.5≤f′_{A}≤f_{A}+0.5,

when the minimum value m (other than 0) that satisfies

m(f_{A}/f_{LD})−Round[m(f_{A}/f_{LD})]=0

is determined, it is sufficient for the value m to satisfy

3≤m≤6.

### (Others)

The calculated expression described above is a necessary condition but is not a sufficient condition. In other words, actually, the luminance unevenness is not moved with well-shaped sine wave vibration by the vibration of the vibration device 14, and other frequency components are mixed due to the pitch of the lens array on the vibration device 14, imaging magnification to the light valve, imaging relationship, vibration amplitude of the vibration device 14, etc. Accordingly, a work to experimentally find out the finest frequency from some vibration frequencies f′_{A} determined above becomes important. Further, at this time, a resonance frequency of the vibration device 14 that is not largely shifted relative to the vibration frequency f′_{A} is also important in terms of vibration.

Moreover, to eliminate luminance unevenness, the moving range of the luminance unevenness when the vibration device 14 is driven is desirably larger than a distance d (see FIG. 5) of the luminance unevenness when the vibration device 14 is stopped, or an inverse number of the spatial frequency of a main component of the luminance unevenness. The driver 15 desirably vibrates the vibration device 14 to move the luminance unevenness during vibration being stopped with the moving range larger than the distance d of the luminance unevenness during vibration being stopped.

Further, in the above description for the optimization method, the case where the vibration device 14 includes the structure in which the cylindrical lens array is disposed in one oblique direction and the fringes appear in one oblique direction has been described as an example; however, a similar optimization method is applicable even in a case where the vibration device 14 includes a structure different from the above-described structure and the fringes are also observed in a direction different from the oblique direction. For example, the optimization method is applicable also to a case where the vibration device 14 includes the periodic structure in a first periodic direction and a second periodic direction different from each other, on one or both of the surfaces. Further, the optimization method is also applicable to a case where the vibration device 14 includes a structure in which the optical surface extending axis As is not oblique to but is parallel to the X direction and the cylindrical lens array is horizontally disposed. Further, the optimization method is also applicable to a case where the vibration device 14 includes the periodic structure in vertical and lateral directions.

### 3 Effects

As described above, according to the present embodiment, the relationship between the light emission frequency f_{LD} of the laser light source and the vibration frequency of the vibration device 14 is optimized to a predetermined condition where the luminance unevenness is less likely to be perceived. This makes it possible to reduce luminance unevenness in illumination light.

The technology of the disclosure makes it possible to realize a projector with higher image quality. Further, the technology of the disclosure is implemented at low cost because a special driving method such as frequency superposition is unnecessary to drive the vibration device 14.

(Difference from Cited Documents)

PTL 2 (Japanese Unexamined Patent Application Publication No. 2013-37335) describes that the vibration frequency is desirably 0.5 times, 1.5 times, . . . the light emission frequency f_{LD}, or is desirably separated from the light emission frequency f_{LD} by 20 Hz or more. The multiplications of 0.5 times, 1.5 times, . . . correspond to the number of fringes m of 2 described in the technology of the disclosure, and the number of fringes is unsuitable because the fringes may be conspicuously observed. Further, even when the vibration frequency is separated from the light emission frequency f_{LD} by 20 Hz or more, the condition where the fringes are conspicuous may be present. It is necessary to increase the number of fringes to 3≤m, as with the technology of the disclosure, to make the fringes inconspicuous.

PTL 3 (Japanese Unexamined Patent Application Publication No. 2008-203699) describes the case where the vibration frequency is 0.5 times or 1.5 times the light emission frequency f_{LD}; however, this is unsuitable for a reason similar to the case of the above-described PTL 2. PTL 3 also describes a case where the vibration frequency is 0.75 times the light emission frequency f_{LD}; however, PTL 3 does not describe propriety of the case, or does not describe at all where an appropriate range falls in.

Note that the effects described in the present specification are illustrative and non-limiting, and other effects may be achieved.

### 4. Other Embodiments

The technology by the disclosure is not limited to the description of the above-described embodiments, and may be variously modified.

For example, the present disclosure may have the following configurations.

(1)

1. An illumination unit, including:

a laser light source that intermittently emits laser light as a source of illumination light at a predetermined light emission frequency;

a vibration device disposed in an optical path of the laser light; and

a driver that vibrates the vibration device at a predetermined vibration frequency to change coherence of the laser light, in which

with respect to a design frequency f_{A} that satisfies

f_{A}−0.5≤f′_{A}≤f_{A}+0.5,

when a minimum value m (other than 0) that satisfies

m(f_{A}/f_{LD})−Round[m(f_{A}/f_{LD})]=0

is determined,

3≤m≤6

is satisfied, where f_{LD} is the light emission frequency and f′_{A} is the vibration frequency.
(2)

The illumination unit according to (1), in which the driver vibrates the vibration device to reduce luminance unevenness occurred on a projection surface to which the illumination light is projected, as compared with luminance unevenness during vibration being stopped that is occurred in a case where the vibration of the vibration device is stopped.

(3)

The illumination unit according to (2), in which the driver vibrates the vibration device to move the luminance unevenness during vibration being stopped by a moving range larger than a distance of the luminance unevenness during vibration being stopped.

(4)

The illumination unit according to (2) or (3), in which the luminance unevenness during vibration being stopped is luminance unevenness in which luminance is varied within 10%.

(5)

The illumination unit according to any one of (1) to (4), in which the vibration device includes a cylindrical lens array.

(6)

The illumination unit according to any one of (1) to (5), in which the light emission frequency f_{LD} is 50 Hz or more.

(7)

A display apparatus, including:

an illumination unit; and

a light modulation device that modulates illumination light from the illumination unit on the basis of an image signal, in which

the illumination unit includes a laser light source that intermittently emits laser light as a source of the illumination light at predetermined light emission frequency, a vibration device disposed in an optical path of the laser light, and a driver that vibrates the vibration device at a predetermined vibration frequency to change coherence of the laser light, and

with respect to a design frequency f_{A} that satisfies

f_{A}−0.5≤f′_{A}≤f_{A}+0.5,

when a minimum value m (other than 0) that satisfies

m(f_{A}/f_{LD})−Round[m(f_{A}/f_{LD})]=0

is determined,

3≤m≤6

is satisfied, where f_{LD} is the light emission frequency and f′_{A} is the vibration frequency.
(8)

The display apparatus according to (7), further including a projection optical system that projects, on a projection surface, the illumination light modulated by the light modulation device.

This application is based upon and claims the benefit of priority of the Japanese Patent Application No. 2016-162770 filed with the Japan Patent Office on Aug. 23, 2016, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An illumination unit, comprising:
a laser light source that intermittently emits laser light as a source of illumination light at a predetermined light emission frequency;
a vibration device disposed in an optical path of the laser light; and
a driver that vibrates the vibration device at a predetermined vibration frequency to change coherence of the laser light, wherein
with respect to a design frequency f_{A} that satisfies
f_{A}−0.5≤f′_{A}≤f_{A}+0.5,
when a minimum value m (other than 0) that satisfies
m(f_{A}/f_{LD})−Round[m(f_{A}/f_{LD})]=0
is determined,
3≤m≤6
is satisfied, where f_{LD} is the light emission frequency and f′_{A} is the vibration frequency.

2. The illumination unit according to claim 1, wherein the driver vibrates the vibration device to reduce luminance unevenness occurred on a projection surface to which the illumination light is projected, as compared with luminance unevenness during vibration being stopped that is occurred in a case where the vibration of the vibration device is stopped.

3. The illumination unit according to claim 2, wherein the driver vibrates the vibration device to move the luminance unevenness during vibration being stopped by a moving range larger than a distance of the luminance unevenness during vibration being stopped.

4. The illumination unit according to claim 2, wherein the luminance unevenness during vibration being stopped is luminance unevenness in which luminance is varied within 10%.

5. The illumination unit according to claim 1, wherein the vibration device comprises a cylindrical lens array.

6. The illumination unit according to claim 1, wherein the light emission frequency f_{LD} is 50 Hz or more.

7. A display apparatus, comprising:
an illumination unit; and
a light modulation device that modulates illumination light from the illumination unit on a basis of an image signal, wherein
the illumination unit includes a laser light source that intermittently emits laser light as a source of the illumination light at predetermined light emission frequency, a vibration device disposed in an optical path of the laser light, and a driver that vibrates the vibration device at a predetermined vibration frequency to change coherence of the laser light, and
with respect to a design frequency f_{A} that satisfies
f_{A}−0.5≤f′_{A}≤f_{A}+0.5,
when a minimum value m (other than 0) that satisfies
m(f_{A}/f_{LD})−Round[m(f_{A}/f_{LD})]=0
is determined,
3≤m≤6
is satisfied, where f_{LD} is the light emission frequency and f′_{A} is the vibration frequency.

8. The display apparatus according to claim 7, further comprising a projection optical system that projects, on a projection surface, the illumination light modulated by the light modulation device.
